(19) United States
(12) Patent Application Publication
(10) Pub. No.: US 2021/0268637 A1
(43) Pub. Date: Sep. 2, 2021

(54) ELECTRIC TOOL

(71) Applicant: MAKITA CORPORATION, Anjo-shi, Aichi (JP)

(72) Inventor: Ken GOTO, Anjo-shi (JP)

(73) Assignee: MAKITA CORPORATION, Anjo-shi, Aichi (JP)

(21) Appl. No.: 17/274,689

(22) PCT Filed: Sep. 25, 2019
(86) PCT No.: PCT/JP2019/037588

§ 371 Date: Mar. 9, 2021

(30) Foreign Application Priority Data
Nov. 30, 2018 (JP) 2018-225565

(51) Int. Cl. B25F 5/00; B24B 23/02

(52) U.S. Cl. CPC B25F 5/008; B25F 5/001; B24B 23/028

(57) ABSTRACT

A power tool allows easy handling. The power tool includes a brushless motor including a stator and a rotor rotatable relative to the stator, a motor housing that is cylindrical and accommodates the brushless motor, a gear housing in front of the motor housing, a grip housing behind the motor housing and extending in a front-rear direction, and being cylindrical and having a smaller diameter than the motor housing, a controller housing behind the grip housing and accommodating a controller including a switching element, and a power cord connected to the controller housing.

### FIELD

The present invention relates to a power tool such as a grinder including a brushless motor and a grip housing extending in the front-rear direction.

### BACKGROUND

A power tool such as a grinder includes a gear housing in front of a motor housing accommodating a motor, and accommodating output components such as gears and a spindle. The power tool also includes a grip housing behind the motor housing, and accommodating electrical components such as a switch. The gear housing, the motor housing, and the grip housing extend in the front-rear direction as a whole. To receive utility power, the grip housing has its rear end connected to a power cord (Japanese Unexamined Patent Application Publication No. 2017-144535).

### BRIEF SUMMARY

### Technical Problem

Such a known power tool may have the center of gravity between the motor and the output components, and thus may have a relatively longer distance in the front-rear direction between a rear grip and the center of gravity. Thus, an operator holding the grip by hand can receive a higher load on the hand, causing poor handling. Power tools with higher efficiency using a blushless motor may be awaited.

One or more aspects of the present invention are directed to a power tool that allows easy handling.

### Solution to Problem

An aspect of the present invention provides a power tool, including:

a brushless motor including a stator and a rotor rotatable relative to the stator;

a motor housing being cylindrical and accommodating the brushless motor;

a gear housing in front of the motor housing;

a grip housing behind the motor housing and extending in a front-rear direction, the grip housing being cylindrical and having a smaller diameter than the motor housing;

a controller housing behind the grip housing and accommodating a controller including a switching element; and

a power cord connected to the controller housing.

### Advantageous Effects

The power tool according to the above aspect of the present invention allows easy handling.

### BRIEF DESCRIPTION OF DRAWINGS

FIG. 1 is a longitudinal sectional view of a grinder.

FIG. 2 is a lateral sectional view of the grinder.

FIG. 3 is an enlarged cross-sectional view taken along line A-A in FIG. 2.

FIG. 4 is an enlarged cross-sectional view taken along line B-B in FIG. 1.

### DETAILED DESCRIPTION

A power tool according to one or more embodiments will now be described with reference to the drawings. The power tool according to the present embodiment is, for example, a grinder.

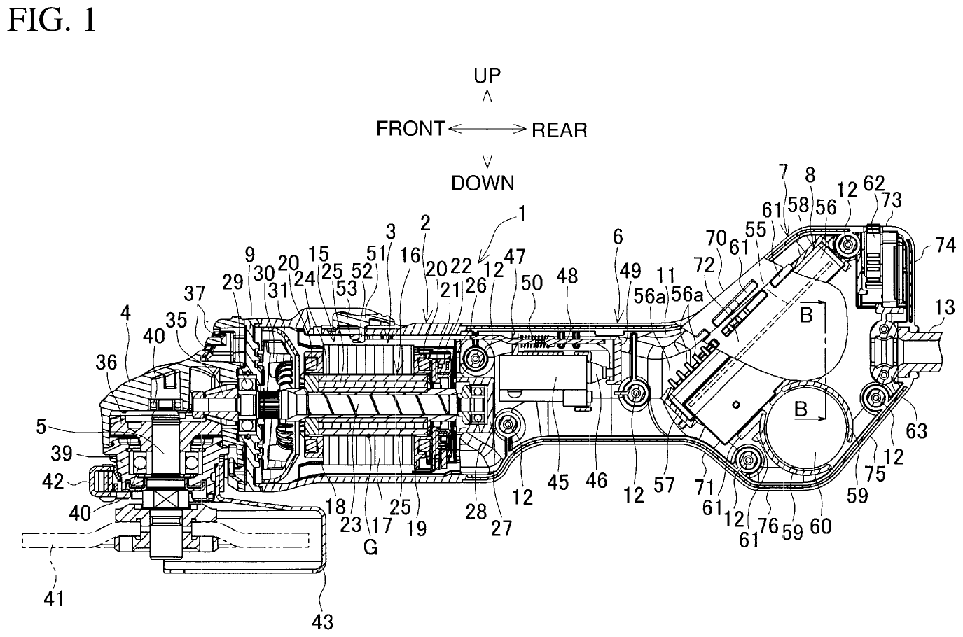

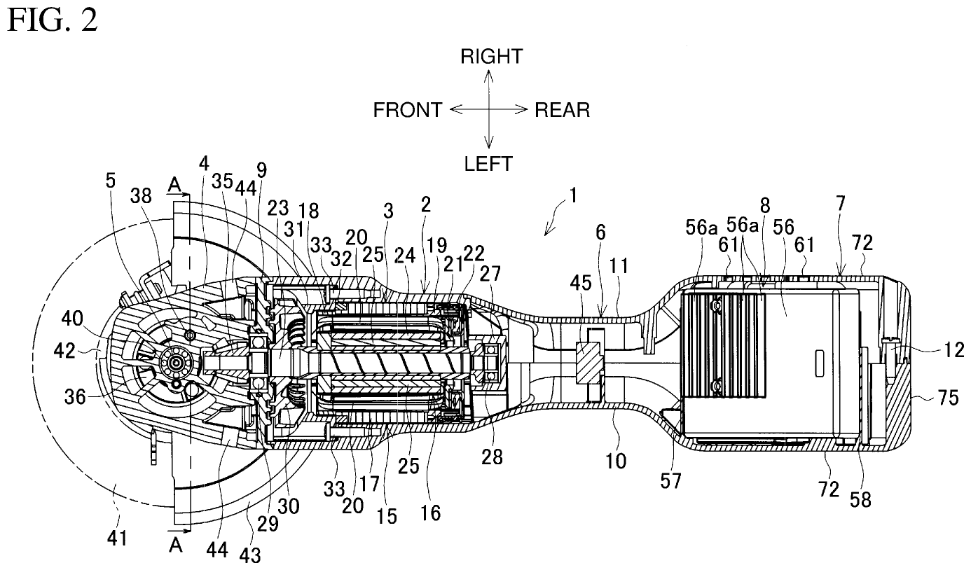

FIG. 1 is a longitudinal sectional view of the grinder. FIG. 2 is a lateral sectional view taken along a plane defined in the front-rear and lateral directions and including the axis of a rotational shaft 23. In FIG. 2, a controller 8 in a controller housing 7 is shown as viewed in a plan, rather than in a cross-sectional view.

A grinder 1 includes a motor housing 2, a gear housing 4, a grip housing 6, and the controller housing 7. The motor housing 2 is cylindrical and accommodates a brushless motor 3. The gear housing 4 is in front of the motor housing 2. The gear housing 4 allows a spindle 5 to protrude downward. The grip housing 6 is cylindrical and is behind the motor housing 2. The grip housing 6 has a smaller diameter than the motor housing 2, and is decentered upward from the motor housing 2. The controller housing 7 is behind the grip housing 6 and accommodates the controller 8. The grinder 1 extends in the front-rear direction as a whole.

The motor housing 2 is a cylinder as one piece. The motor housing 2 and the gear housing 4 are connected to each other with a disk-shaped gear housing cover 9 between them. The grip housing 6 and the controller housing 7 are laterally dividable into a left housing half 10 and a right housing half 11. The left housing half 10 is integral with the motor housing 2. The right housing half 11 on the right of the housing half 10 is connected to the housing half 10 with multiple screws 12. The controller housing 7 has its rear surface connected to a power cord 13.

The brushless motor 3 is an inner-rotor brushless motor including a stator 15 and a rotor 16 inside the stator 15. The stator 15 includes a cylindrical stator core 17, a front insulator 18, a rear insulator 19, and six coils 20. The stator core 17 includes multiple steel plates stacked on one another. The front insulator 18 is located on an axially front end face of the stator core 17. The rear insulator 19 is located on an axially rear end face of the stator core 17. The six coils 20 are wound around the stator core 17 with the front insulator 18 and the rear insulator 19 between them. A sensor circuit board 21 and a short-circuiting member 22 are attached to the rear insulator 19 at the rear. The short-circuiting member 22 has sheet metal terminals electrically connected to the coils 20 to form a three-phase connection. The sensor circuit board 21 includes three rotation detectors (not shown). The three rotation detectors detect the positions of permanent magnets 25 located in the rotor 16 and output rotation detection signals. Signal wires from the rotation detectors extend from a lower portion of the sensor circuit board 21. Three-phase power wires to be fused to the sheet metal terminals extend from a lower portion of the short-circuiting member 22.

The rotor 16 includes the rotational shaft 23, a rotor core 24, and the four permanent magnets 25. The rotational shaft 23 is aligned with the axis of the rotor 16. The rotor core 24 is substantially cylindrical. The rotor core 24 surrounds the rotational shaft 23 and includes multiple steel plates stacked on one another. The permanent magnets 25 are plates fixed inside the rotor core 24.

The motor housing 2 includes a partition 26 on its rear end to separate the motor housing 2 from the grip housing 6. The rotational shaft 23 has its rear end axially supported by a bearing holder 27 at the center of the partition 26 with a bearing 28 between them. The rotational shaft 23 has its front end extending through the gear housing cover 9, axially supported by a bearing 29 held on the gear housing cover 9, and protruding into the gear housing 4. The rotational shaft 23 receives a centrifugal fan 30 at the rear of the gear housing cover 9. The motor housing 2 includes a bawl-shaped baffle plate 31 on its front inner surface. The baffle plate 31 covers the centrifugal fan 30 at the rear toward its outer circumference. As shown in FIG. 2, the baffle plate 31 is positioned with its leg 32 extending rearward and fastened to the inner surface of the motor housing 2 with screws 33, which are placed through the front of the leg 32. The gear housing cover 9 has through-holes (not shown) to direct air from the centrifugal fan 30 forward along the baffle plate 31 and into the gear housing 4.

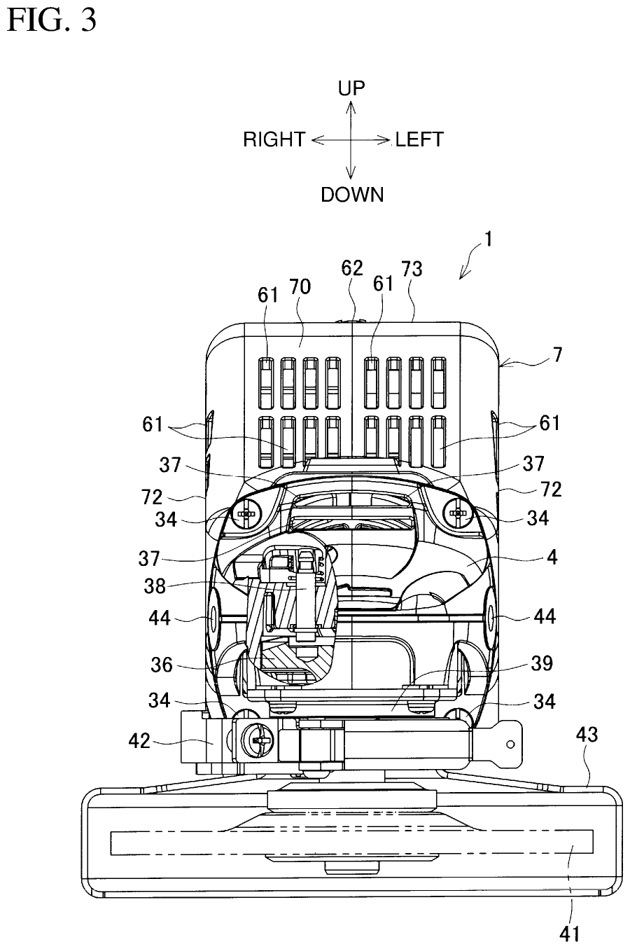

As shown in FIG. 3, the gear housing 4 is connected to the motor housing 2 with four screws 34 screwed into the motor housing 2 through its front four corners with the gear housing cover 9 between them. A bevel gear 35 is fixed on the front end of the rotational shaft 23 protruding into the gear housing 4. The bevel gear 35 meshes with a bevel gear 36 fixed on the upper end of the spindle 5. The gear housing 4 has outlets 37 in its front surface. The gear housing 4 includes a shaft lock 38 on its upper surface. The shaft lock 38 can lock, when pressed, the spindle 5 not to rotate via the bevel gear 36. The spindle 5 is axially supported by upper and lower bearings 40 and protrudes downward. The upper bearing 40 is held on the gear housing 4. The lower bearing 40 is held on a bearing box 39 attached to a lower portion of the gear housing 4. The spindle 5 has a lower end to receive a tip tool 41, such as a grinding disc. The bearing box 39 can receive, on its outer circumference, a wheel cover 43 attached with a belt clamp 42. The wheel cover 43 covers a rear half of the tip tool 41. The gear housing 4 has, on its right and left side surfaces, screw holes 44 to receive a side grip.

The grip housing 6 includes, in its upper portion, a switch 45 held by a holding rib 47 in a front-rear posture with a button 46 facing rearward. The button 46 is pressed to turn on the switch 45. The holding rib 47 protrudes from the inner surface of the grip housing 6. This structure leaves, below the switch 45, a space allowing the power wires and the signal wires to extend through. The holding rib 47 supports, above the switch 45, a slide bar 48 in a manner slidable in the front-rear direction. The slide bar 48 includes a pressing member 49 on its rear end. The pressing member 49 bends downward behind the switch 45 to be located behind the button 46. The slide bar 48 includes a coil spring 50 wound around the slide bar 48 between the holding rib 47 and a portion of the slide bar 48. In a normal state, the slide bar 48 is urged to a retracted position (FIG. 1) not to allow the pressing member 49 to press the button 46. The motor housing 2 includes, on its upper surface, a switch knob 51. The switch knob 51 is operable to slide in the front-rear direction. The switch knob 51 includes, on its lower surface, an L-shaped engagement tab 52 protruding inside the motor housing 2 through a slit 53. The tab 52 extends in the front-rear direction in the motor housing 2 to engage with the front end of the slide bar 48.

In response to the switch knob 51 being slid forward with fingers, the slide bar 48 is slid forward against an urging force from the coil spring 50. The pressing member 49 in the rear end of the slide bar 48 then moves forward and presses the button to turn on the switch 45. In response to the switch knob 51 being released from fingers, the slide bar 48 is slid to the retracted position under the urging force from the coil spring 50. This releases the button 46 from pressure from the pressing member 49 to turn off the switch 45.

The controller 8 accommodated in the controller housing 7 includes a dish-shaped case 56. The case 56 is formed from aluminum. The case 56 accommodates a control circuit board 55 including six switching elements (not shown) corresponding to the coils 20 in the brushless motor 3, a microcomputer (not shown), and other components. The controller 8 is supported by a support rib 57 on the front inner surface of the housing halves 10 and 11, and by a support rib 58 on the rear inner surface of the housing halves 10 and 11. The rear support rib 58 is located upward from the front support rib 57. In this structure, the controller 8 is supported in a tilted posture with its rear end more upward than its front end with respect to the axis of the rotational shaft 23. As shown in FIGS. 1 and 2, the case 56 has, on its upper surface, laterally extending heat-dissipating ribs 56a that stand at predetermined intervals in the front-rear direction. In this state, the case 56 is in a posture with its bottom located frontward and its opening located rearward.

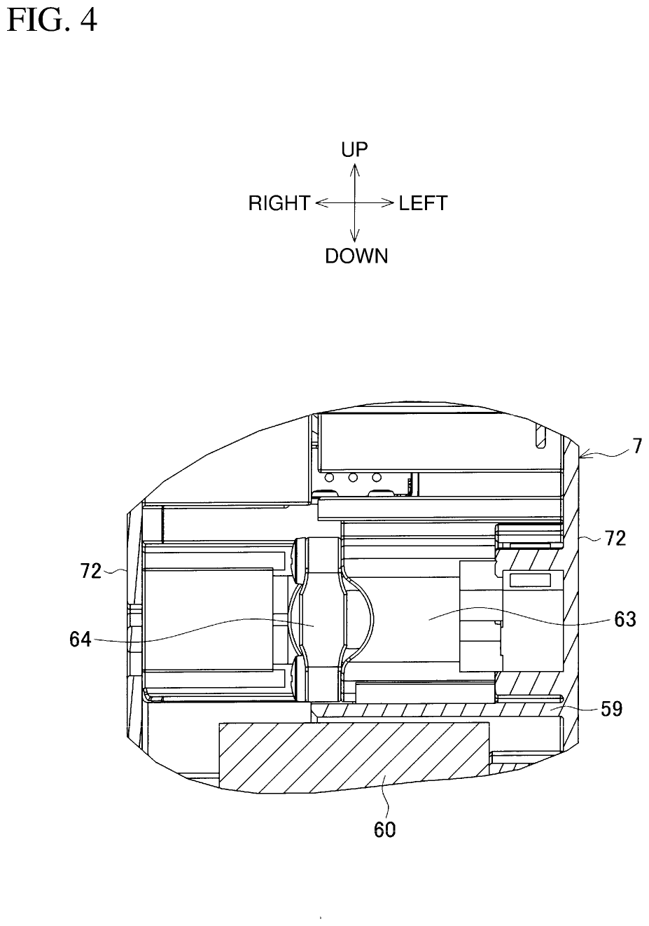

The tilted controller 8 creates a space below the controller 8 at the rear. As shown in FIG. 4, the space contains a capacitor 60 located below the controller 8 and laterally supported by semicircular ribs 59 on the inner surface of the housing half 10.

The controller housing 7 has an upper front surface 70 tilted downward toward the front and aligned with the tilted upper surface of the controller 8. The controller housing 7 has a lower front surface 71 tilted downward toward the rear and aligned with the tilted front surface of the controller 8. The controller housing 7 has multiple inlets 61 in its upper front surface 70 and in its right and left side surfaces 72. The right and left side surfaces 72 are flat surfaces parallel to each other and extending frontward, rearward, upward, and downward. The inlets 61 in the side surfaces 72 are located from a portion frontward from the case 56 to a portion downward from the case 56 as viewed laterally.

The controller housing 7 has a flat upper surface 73 extending frontward, rearward, rightward, and leftward. The upper surface 73 includes a partially exposed portion of a speed adjusting dial 62 behind the controller 8. The controller housing 7 has a flat upper rear surface 74 extending upward, downward, rightward, and leftward. The flat upper rear surface 74 is connected to the power cord 13. The power cord 13 is fastened to a receiver 63 (FIG. 4) standing on the inner surface of the housing half 10 with a cord clamp 64 screwed at the right of the cord clamp 64. This positions the power cord 13 inside the controller housing 7. The controller housing 7 has a lower rear surface 75 tilted downward toward the front, similarly to the upper front surface 70. The controller housing 7 has a flat lower surface 76 extending frontward, rearward, rightward, and leftward, similarly to the upper surface 73.

The controller housing 7 has an upper part defined by the upper front surface 70, the upper surface 73, the upper rear surface 74, and the right and left side surfaces 72. The upper part protrudes more upward than the motor housing 2 and the grip housing 6. The controller housing 7 has a lower part defined by the lower front surface 71, the lower surface 76, the lower rear surface 75, and the right and left side surfaces 72. The lower part protrudes more downward than the lower surface of the grip housing 6. The lower surface 76 is located downward from the lower surface of the motor housing 2.

As shown in FIG. 1, the grinder 1 has its center of gravity G inside the motor housing 2 as viewed laterally. More specifically, the center of gravity G is located downward from the rotational shaft 23 of the brushless motor 3 and substantially in a central portion of the stator 15 in the front-rear direction.

The tip tool 41 may be, for example, a grinding disc with a diameter of 100 to 150 mm. The grinder 1 may have a normal rated power of, for example, 1000 to 1400 W.

With the grinder 1 according to the present embodiment, an operator holding the grip housing 6 with a hand slides the switch knob 51 forward to move the slide bar 48 forward, thus causing the pressing member 49 to press the button 46 to turn on the switch 45. Power supply through the power cord 13 drives the brushless motor 3. More specifically, the microcomputer in the controller 8 receives the rotation detection signals indicating the positions of the permanent magnets 25 in the rotor 16 output from the rotation detectors in the sensor circuit board 21, and determines the rotation state of the rotor 16. The microcomputer in the controller 8 then controls the on-off state of each switching element depending on the determined rotation state and feeds a current sequentially through the coils 20 in the stator 15 to rotate the rotor 16. The rotational shaft 23 thus rotates to rotate the spindle 5 via the bevel gears 35 and 36 to allow grinding or other operations using the tip tool 41.

In this state, the hand holding the grip housing 6 is located at a shorter distance from the center of gravity G. The grinder 1 thus allows easy handling and reduces fatigue in the operator's hand.

As the centrifugal fan 30 rotates together with the rotational shaft 23, the outside air is drawn through the inlets 61 in the upper front surface 70 and the right and left side surfaces 72 of the controller housing 7, and moves forward while in contact with the upper and lower surfaces, the right and left side surfaces, and the front surface of the case 56 in the controller 8.

The outside air entering in the three directions comes in contact with the controller 8 to cool the controller 8 efficiently. In particular, the case 56 has the heat-dissipating ribs 56a on its upper surface. This facilitates heat dissipation.

Airflow moving forward from the controller housing 7 enters the grip housing 6 and then the motor housing 2. After the airflow passes through and cools the brushless motor 3, the airflow passes through the baffle plate 31, enters the gear housing 4 through the gear housing cover 9, and is then discharged through the outlets 37.

In response to the switch knob 51 being released from fingers or slid rearward, the slide bar 48 is retracted to release the button 46 from pressure from the pressing member 49. This turns off the switch 45 and stops the brushless motor 3.

The grinder 1 according to the present embodiment includes the brushless motor 3 including the stator 15 and the rotor 16 rotatable relative to the stator 15, the motor housing 2 being cylindrical and accommodating the brushless motor 3, the gear housing 4 in front of the motor housing 2, the grip housing 6 behind the motor housing 2 and extending in the front-rear direction, and being cylindrical and having a smaller diameter than the motor housing 2, the controller housing 7 behind the grip housing 6 and accommodating the controller 8 including the switching elements, and the power cord 13 connected to the controller housing 7. In this structure, the controller housing 7 is behind the grip housing 6 to place the center of gravity G at a shorter distance from the grip housing 6, thus allowing easy handling. This structure also allows the grip housing 6 to be thinner and be easily gripped.

The controller housing 7 has the inlets (vents) 61. The controller housing 7 accommodates the case (heat-dissipating member) 56 having the heat-dissipating ribs 56a. This effectively cools the controller 8.

The capacitor 60 is located below the controller 8 and accommodated in the controller housing 7. This structure allows a larger capacitor 60 to be easily accommodated in the controller housing 7.

The controller housing 7 has the inlets 61 in its upper front surface 70 and its right and left side surfaces 72 facing the outer surface of the controller 8. This structure allows air to reliably come in contact with the outer surface of the controller 8 and thus effectively cools the controller 8.

The controller 8 is accommodated in the controller housing 7 with its front portion tilted downward. The controller housing 7 is thus downsized in the front-rear direction and becomes compact.

The gear housing 4 accommodates the spindle 5 to receive the tip tool 41. The power tool 1 has its center of gravity G inside the motor housing 2. The center of gravity G is thus located effectively at a shorter distance from the grip housing 6.

The controller 8 includes the case 56 having its bottom located frontward and its opening located rearward, and the control circuit board 55 accommodated in the case 56. The inlets 61 are located frontward from the bottom. In this structure, the opening of the case 56 faces downward. The control circuit board 55 is less susceptible to dust or iron powder entering through the inlets 61.

The controller may be at a position different from the position in the above embodiment. In some embodiments, the controller may be accommodated in a posture extending in the front-rear direction or in a vertical posture extending frontward, rearward, upward, and downward, rather than extending in a tilted posture.

In some embodiments, a heat-dissipating member may have a different number of heat-dissipating ribs with a different shape. The heat-dissipating member is not limited to a case serving as a heat-dissipating member. A separate heat-dissipating member may be connected to the case, or a heat-dissipating member held on the inner surface of a controller housing may be in contact with the case.

In some embodiments, any number of and any position of vents, or inlets, may be used appropriately depending on the position of the controller. With air flowing in the opposite direction, the controller housing may have outlets, and the inlets may be located in a gear housing or a motor housing.

In some embodiments, the grip housing may be a hollow prism rather than a cylinder, and may be coaxially with respect to the motor housing rather than being decentered upward from the motor housing.

The present invention is applicable not only to a grinder but also to other power tools, such as an angle screw driver and an angle impact driver.

### REFERENCE SIGNS LIST

1 grinder
2 motor housing
3 brushless motor
4 gear housing
5 spindle
6 grip housing
7 controller housing
8 controller
10, 11 housing half
15 stator
16 rotor
23 rotational shaft
30 centrifugal fan
37 outlet
41 tip tool
45 switch
55 control circuit board
56 case
56a heat-dissipating rib
57, 58 support rib
61 inlet
G center of gravity

1. A power tool, comprising:
a brushless motor including a stator and a rotor rotatable relative to the stator;
a motor housing being cylindrical and accommodating the brushless motor;
a gear housing in front of the motor housing;
a grip housing behind the motor housing and extending in a front-rear direction, the grip housing being cylindrical and having a smaller diameter than the motor housing;
a controller housing behind the grip housing and accommodating a controller including a switching element; and
a power cord connected to the controller housing.

2. The power tool according to claim 1, wherein
the controller housing has a vent, and
the controller housing accommodates a heat-dissipating member to dissipate heat from the controller.

3. The power tool according to claim 1, further comprising:
a capacitor located below the controller and accommodated in the controller housing.

4. The power tool according to claim 2, wherein
the vent faces an outer surface of the controller.

5. The power tool according to claim 1, wherein
the controller is accommodated in the controller housing with a front portion of the controller tilted downward.

6. The power tool according to claim 1, wherein
the gear housing accommodates a spindle to receive a tip tool.

7. The power tool according to claim 1, wherein
the power tool has a center of gravity inside the motor housing.

8. The power tool according to claim 2, wherein
the controller includes
a case having a bottom located frontward and an opening located rearward, and a control circuit board accommodated in the case, and
the vent is located frontward from the bottom.

9. The power tool according to claim 1, wherein
the controller housing has a lower surface downward from a lower surface of the grip housing.

10. The power tool according to claim 1, wherein
the controller housing has a lower surface downward from a lower surface of the motor housing.

11. The power tool according to claim 1, wherein
the grip housing is decentered upward from the motor housing.

12. The power tool according to claim 2, further comprising:
a capacitor located below the controller and accommodated in the controller housing.

13. The power tool according to claim 2, wherein
the controller is accommodated in the controller housing with a front portion of the controller tilted downward.

14. The power tool according to claim 3, wherein
the controller is accommodated in the controller housing with a front portion of the controller tilted downward.

15. The power tool according to claim 4, wherein
the controller is accommodated in the controller housing with a front portion of the controller tilted downward.

16. The power tool according to claim 2, wherein
the gear housing accommodates a spindle to receive a tip tool.

17. The power tool according to claim 3, wherein
the gear housing accommodates a spindle to receive a tip tool.

18. The power tool according to claim 4, wherein
the gear housing accommodates a spindle to receive a tip tool.

19. The power tool according to claim 5, wherein
the gear housing accommodates a spindle to receive a tip tool.

20. The power tool according to claim 2, wherein
the power tool has a center of gravity inside the motor housing.
